(19) United States
(12) Patent Application Publication
(10) Pub. No.: US 2012/0187639 A1
(43) Pub. Date: Jul. 26, 2012

(54) HOLDING DEVICE FOR HAND MACHINE TOOLS, IN PARTICULAR HOLDING DEVICE FOR A DRILL AND/OR CHIPPING HAMMER

(75) Inventors: Hubert Steinke, Leinfelden-Echterdingen (DE); Lars Schmid, Nuertingen (DE); Johannes Schnitzler, Reutlingen (DE); Gerhard Meixner, Filderstadt (DE); Christian Koepf, Wherstead (GB); Jan Koalick, Leinfelden (DE)

(73) Assignee: Robert Bosch GmbH, Stuttgart (DE)

(21) Appl. No.: 13/381,542

(22) PCT Filed: Apr. 30, 2010
(86) PCT No.: PCT/EP2010/055880

§ 371 Date: Apr. 11, 2012

(30) Foreign Application Priority Data
Jun. 30, 2009 (DE) 10 2009 027 316.6

(51) Int. Cl. B25D 17/08

(52) U.S. Cl. 279/19

(57) ABSTRACT

A holding device for hand machine tools, in particular a drill and/or a chipping hammer holding device, includes a hammer tube and at least one blocking body, which, when installed, connects the hammer tube to at least one additional holding component. The blocking body is provided with at least one blocking surface that is curved around at least one load tipping axis.

### PRIOR ART

The invention is based on a holding device for a portable power tool according to the preamble of claim 1.

Rotary- and chisel-hammer holding devices are known which have a hammer tube and locking bodies which connect the hammer tube to a tool chuck in the fitted state.

### DISCLOSURE OF THE INVENTION

The invention is based on a holding device for a portable power tool, in particular a rotary- and/or chisel-hammer holding device, having a hammer tube and at least one locking body which connects the hammer tube to at least one further holding component in a fitted state.

It is proposed that the locking body have at least one locking surface curved about at least one load tilting axis. In this case, the expression “hammer tube” is intended to mean in particular an elongated, hollow component, in particular a hollow shaft, in which a striker of a percussion mechanism, a piston, in particular a skirt-type piston, and/or a percussion pin interacting with a striker is guided in the longitudinal extent of the hammer tube. The expression “load tilting axis” is intended to mean in particular an axis about which the locking body is tilted during a main load, such as, in particular, during a load on the hammer tube and/or on the holding component, to be connected to the hammer tube, in the axial direction of the hammer tube and/or in the circumferential direction of the hammer tube. Large load-bearing areas, small surface pressures, low wear and a long service life can be advantageously achieved by an appropriate configuration.

In this case, the locking surface can have various curvatures which seem appropriate to the person skilled in the art and can also be produced by various methods which seem appropriate to the person skilled in the art, e.g. by means of material removal processes, e.g. milling processes. In an especially advantageous manner, however, the locking surface is formed at least partly by a cambered surface, i.e. a surface produced by a plastic deformation operation, such as, in particular, by a rolling operation, as a result of which the service life can be further increased. The locking surface of the locking body can be designed in principle to be at least partly concave and/or, in an especially advantageous manner, to be at least partly and preferably completely convex.

Various components of the holding device for the portable power tool which seem appropriate to the person skilled in the art can be connected to the hammer tube by means of one or more corresponding locking bodies. However, if the holding device for the portable power tool has a tool holder having at least one holding surface which corresponds with the locking body in at least one operating state, an especially space-saving design, in particular without an additional holding flange, can be achieved. In this connection, the expression “tool holder” is intended to mean in particular a component which has an accommodating region for an application tool, such as in particular for a drill and/or chisel.

In a further configuration of the invention, it is proposed that the hammer tube and, in an especially advantageous manner, at least one further holding component have at least one curved holding surface which corresponds with the curved locking surface in at least one operating state, as a result of which surface pressure which occurs and wear which occurs can be further reduced.

The locking body can in principle have various shapes which seem appropriate to the person skilled in the art; for example, said locking body can be designed to be spherical, parallelepiped-shaped, bean-shaped, etc., and preferably correspondingly adapted mating surfaces should then be provided. In an especially advantageous manner, however, the locking body has, in the fitted state, a greater extent at least in the radial direction of the hammer tube than in the axial direction of the hammer tube, as a result of which advantageous overlapping can be achieved.

It is also proposed that the locking body have at least one curved end face and/or a curved lateral surface. In this case, the expression “end face” is intended to mean in particular a surface pointing in the longitudinal direction of the locking body, preferably in the radial direction of the hammer tube, and a “lateral surface” is intended to mean in particular a surface pointing transversely to a longitudinal direction and extending about a longitudinal axis of the locking body. Advantageous force flows and small surface pressures can be advantageously achieved by an appropriate configuration, specifically, in particular, if the locking body has at least two locking surfaces.

### DRAWING

Further advantages follow from the description of the drawing below. Exemplary embodiments of the invention are shown in the drawing. The drawing, the description and the claims contain numerous features in combination. The person skilled in the art will also expediently consider the features individually and combine them to form appropriate further combinations.

In the drawing:

FIG. 1 shows a schematic illustration of a rotary and chisel hammer with a partial section through a rotary- and chisel-hammer holding device,

FIG. 2 shows an enlarged illustration of a detail from FIG. 1, with play and tilt angle shown greatly exaggerated,

FIG. 3 shows an enlarged illustration of a detail of a first alternative, with play and tilt angle shown greatly exaggerated,

FIG. 4 shows an enlarged illustration of a detail of a second alternative, with play and tilt angle shown greatly exaggerated.

### DESCRIPTION OF THE EXEMPLARY EMBODIMENTS

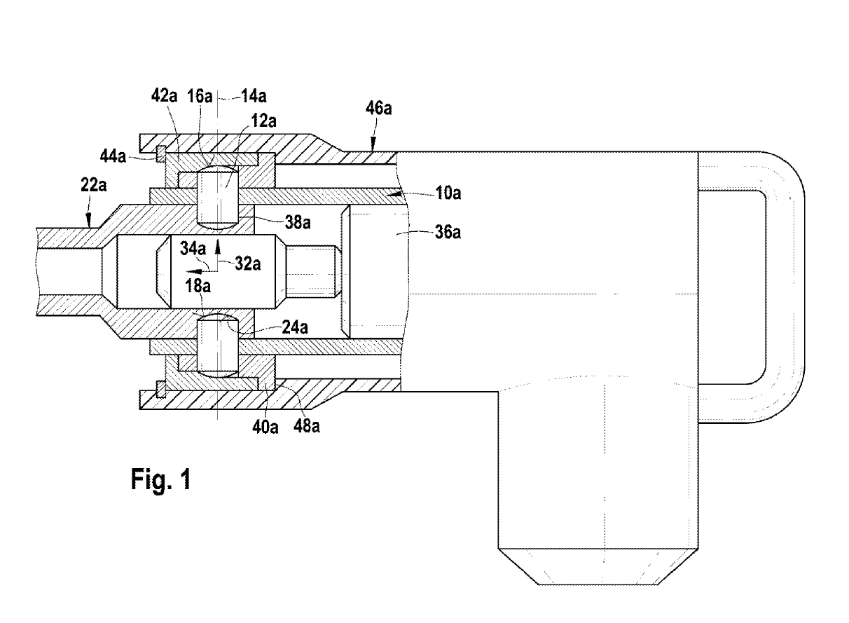

FIG. 1 shows a schematically illustrated rotary and chisel hammer with a partial section through a rotary- and chisel-hammer holding device of the rotary and chisel hammer. The rotary- and chisel-hammer holding device comprises a hammer tube 10a in which a striker 36a of a percussion mechanism (not shown in any more detail) is guided. Furthermore, the rotary- and chisel-hammer holding device has three locking bodies 12a of the same kind which are uniformly distributed over the circumference of the hammer tube 10a and which, in a fitted state, connect the hammer tube 10a to a holding component for conjoint rotation and in an axially fixed manner, said holding component being formed by a tool holder 22a. The tool holder 22a has an outside diameter which is smaller than an inside diameter of the hammer tube 10a and is inserted into the hammer tube 10a.

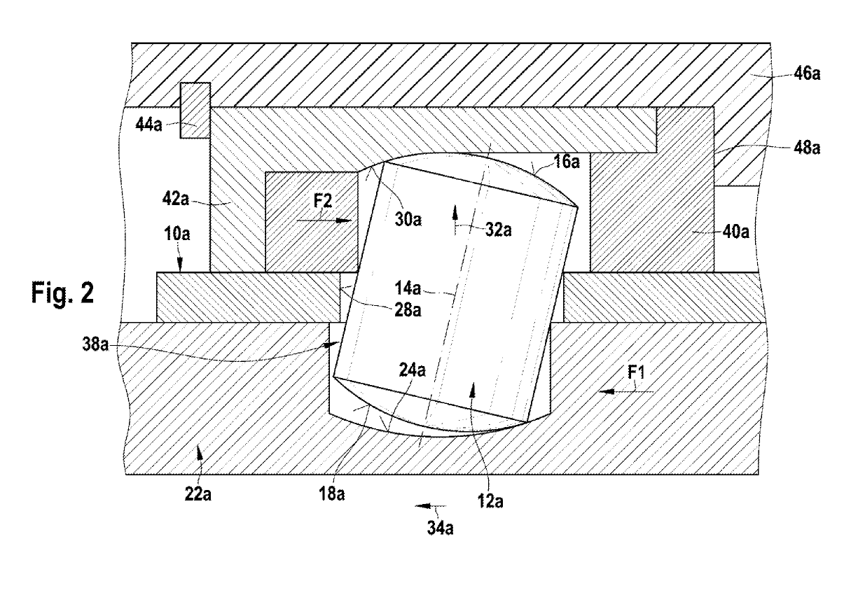

The locking body 12a passes radially through a round aperture in the hammer tube 10a, said aperture being defined by a holding surface 28a. The locking body 12a has two locking surfaces 16a, 18a (FIG. 2) which are convexly curved about its load tilting axis 14a and are formed by cambered surfaces. The locking body 12a is of cylinder-like design and has, in the fitted state, a greater extent in the radial direction 32a of the hammer tube 10a than in the axial direction 34a of the hammer tube 10a. The locking surfaces 16a, 18a are formed by opposite end faces of the locking body 12a.

In accordance with the number of locking bodies 12a, the tool holder 22a has blind-hole recesses 38a on its inner circumference, specifically blind holes, the center axes of which extend radially relative to the hammer tube 10a. The blind-hole recess 38a is defined in the radial direction by a holding surface 24a of the tool holder 22a, said holding surface 24a corresponding with the locking body 12a in an operating state and being concavely curved about the load tilting axis 14a. Furthermore, the rotary- and chisel-hammer holding device has, in the radially outer region of the hammer tube 10a, a perforated ring 40a, through which the locking body 12a passes in the radial direction. In the radially outer region of the perforated ring 40a, the rotary- and chisel-hammer holding device has a holding component which is formed by a holding ring 42a and which has a concavely curved holding surface 30a on its side pointing radially inward, said holding surface 30a corresponding with the locking surface 16a of the locking body 12a in an operating state. The perforated ring 40a has a stepped outer contour and the holding ring 42a has a stepped inner contour. The inner contour and the outer contour are matched to one another, and the inner contour and the outer contour engage one inside the other in a positive-locking manner in the axial and radial directions. The perforated ring 40a and the holding ring 42a are secured in the axial direction 34a of the hammer tube 10a inside a portable power tool housing 46a by means of a clamping ring 44a and by means of a step 48a integrally formed on the portable power tool housing 46a.

If, for example, a force F1 loading the tool holder 22a in an axial direction away from the striker 36a occurs during operation, the locking body 12a is tilted about the load tilting axis 14a running perpendicularly to the axial direction 34a of the hammer tube 10a by the force F1 and a reaction force F2 opposed to the force F1, as shown exaggerated in FIG. 2 for illustration. As a result of the curved locking surfaces 16a, 18a and the curved holding surfaces 24a, 30a, large contact areas, small surface pressures and low wear are advantageously achieved.

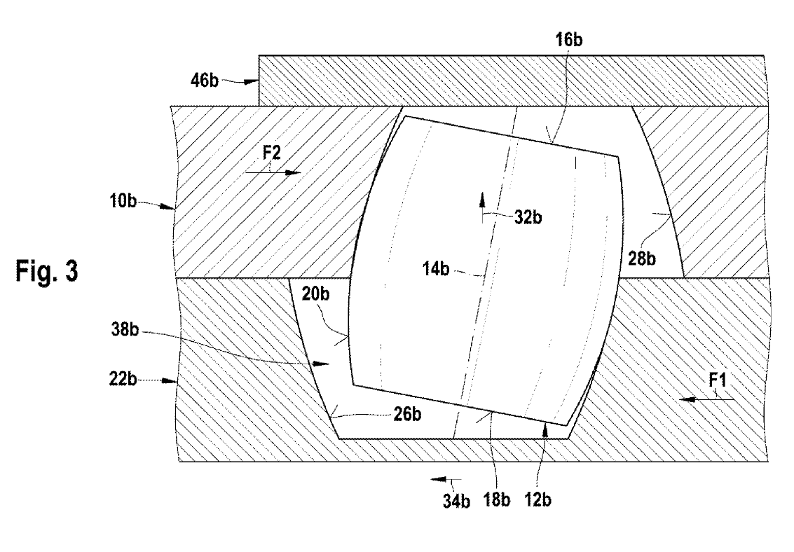

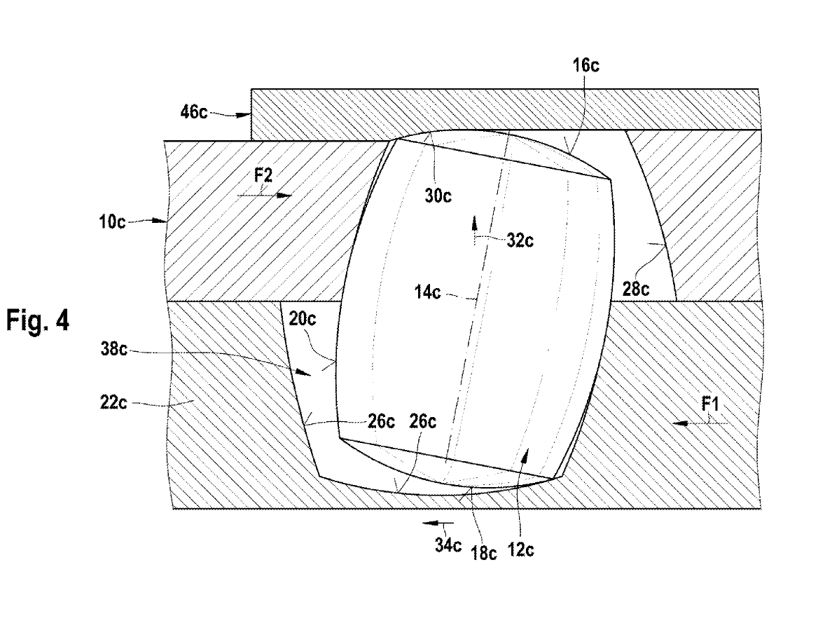

FIGS. 3 and 4 show details of alternative exemplary embodiments. Components, features and functions that remain the same are basically marked with the same reference numerals. To distinguish between the exemplary embodiments, the letters a to c are added to the reference numerals. The description below is basically restricted to the differences from the exemplary embodiment in FIGS. 1 and 2. With regard to features and functions that remain the same, reference may be made to the description of the exemplary embodiment in FIGS. 1 and 2.

FIG. 3 shows a detail of an alternative rotary- and chisel-hammer holding device having barrel-shaped locking bodies 12b which connect together a hammer tube 10b and a tool holder 22b of the rotary- and chisel-hammer holding device for conjoint rotation and in an axially fixed manner. The locking body 12b has a curved locking surface 20b, specifically a convexly curved lateral surface, and flat end faces 16b, 18b. For each locking body 12b, the hammer tube 10b has a radial through-aperture which is defined by a holding surface 28b of the hammer tube 10b, said holding surface 28b being concavely curved about a load tilting axis 14b and corresponding with the locking surface 20b in an operating state. The holding surface 28b of the hammer tube 10b is a lateral surface or encloses the locking body 12b by 360°. Furthermore, the tool holder 22b has a radial blind-hole recess which is defined by a holding surface 26b concavely curved about the load tilting axis 14b and corresponding with the locking surface 20b during operation. The holding surface 26b is formed by a lateral surface or encloses the locking body 12b by 360°. Compared with the exemplary embodiment in FIGS. 1 and 2, the hammer tube 10b is radially defined in the region of the locking body 12b directly by a portable power tool housing 46b. The hammer tube 10b is directly mounted in the portable power tool housing 46b.

FIG. 4 shows a detail of an alternative rotary- and chisel-hammer holding device having barrel-shaped locking bodies 12c which connect together a hammer tube 10c and a tool holder 22c of the rotary- and chisel-hammer holding device for conjoint rotation and in an axially fixed manner. The locking body 12c has three curved locking surfaces 16c, 18c, 20c, specifically a convexly curved lateral surface and two convexly curved end faces. For each locking body 12c, the hammer tube 10c has a radial through-aperture which is defined by a holding surface 28c of the hammer tube 10c, said holding surface 28c being concavely curved about a load tilting axis 14c and corresponding with the locking surface 20c in an operating state. Furthermore, the tool holder 22c has a radial blind-hole recess which is defined by a holding surface 26c concavely curved about the load tilting axis 14c and corresponding with the locking surface 20c during operation. The holding surface 26c is formed by a lateral surface or encloses the locking body 12c by 360°. The hammer tube 10c is radially defined in the region of the locking body 12c directly by a portable power tool housing 46c. The curved end faces of the locking body 12c correspond with a concave holding surface 30c of the portable power tool housing 46c pointing radially inward and with a concave holding surface 24c of the tool holder 22c pointing radially outward.

1. A holding device for a portable power tool, in particular a rotary- and/or chisel-hammer holding device, comprising:
a hammer tube; and
at least one locking body which connects the hammer tube to at least one further holding component in a fitted state,
wherein the locking body has at least one locking surface curved about at least one load tilting axis.

2. The holding device for a portable power tool as claimed in claim 1, wherein the locking surface is formed at least partly by a cambered surface.

3. The holding device for a portable power tool as claimed in claim 1, further comprising a tool holder having at least one holding surface which corresponds with the locking body in at least one operating state.

4. The holding device for a portable power tool as claimed in claim 1, wherein the hammer tube has at least one curved holding surface which corresponds with the curved locking surface in at least one operating state.

5. The holding device for a portable power tool as claimed in claim 1, wherein the at least one further holding component includes a curved holding surface which corresponds with the curved locking surface in at least one operating state.

6. The holding device for a portable power tool as claimed in claim 1, wherein the locking body has, in the fitted state, a greater extent in a radial direction of the hammer tube than in an axial direction of the hammer tube.

7. The holding device for a portable power tool as claimed in claim 1, wherein the locking body has at least one curved end face.

8. The holding device for a portable power tool as claimed in claim 1, wherein the locking body has at least one curved lateral surface.

9. The holding device for a portable power tool as claimed in claim 1, wherein the locking body has at least two curved locking surfaces.

10. A portable power tool comprising:
a tool-holding device including a hammer tube and at least one locking body which connects the hammer tube to at least one further holding component in a fitted state,
wherein the locking body has at least one locking surface curved about at least one load tilting axis.
